(19) United States
(12) Patent Application Publication
(10) Pub. No.: US 2026/0310033 A1
(43) Pub. Date: Oct. 8, 2026

(54) METHOD AND APPARATUS FOR CONTROLLING ELECTROCHROMIC GLASS IN VEHICLE

(71) Applicants: Hyundai Motor Company, Seoul (KR); Kia Corporation, Seoul (KR)

(72) Inventor: Ji Hoon SUNG, Hwaseong-si (KR)

(73) Assignees: Hyundai Motor Company, Seoul (KR); Kia Corporation, Seoul (KR)

(21) Appl. No.: 19/350,323

(22) Filed: Oct. 6, 2025

(30) Foreign Application Priority Data
Apr. 4, 2025 (KR) 10-2025-0043908

(51) Int. Cl. G02F 1/163; B60J 3/02; B60J 3/04

(52) U.S. Cl. CPC G02F 1/163; B60J 3/02; B60J 3/04

(57) ABSTRACT

In a method and an apparatus for controlling electrochromic glass in vehicles, the method includes setting a vertical blocking angular range based on which angular range a vertical angle of incidence falls in among angular ranges determined respectively for a plurality of regions within the electrochromic glass, setting a horizontal blocking angular range based on which angular range a horizontal angle of incidence falls in among the angular ranges determined respectively for the plurality of regions within the electrochromic glass, determining a blocking region based on the vertical blocking angular range and the horizontal blocking angular range, and tinting the blocking region.

### CROSS-REFERENCE TO RELATED APPLICATION

The present application is based on, and claims priority from, Korean Patent Application Number 10-2025-0043908, filed Apr. 4, 2025, the present disclosure of which is incorporated by reference herein in its entirety.

### FIELD OF THE PRESENT DISCLOSURE

The present disclosure relates to a method and an apparatus for controlling electrochromic glass in vehicles.

### BACKGROUND

The statements in the present section merely provide background information related to the present disclosure and do not necessarily form related art.

Glare from the sun while driving is one main factor that impedes driver vision and impairs safety. To block this, vehicles are typically equipped with mechanical sun visors. Mechanical sun visors can be manually operated by the driver to block sunlight, but they have the following limitations.

First, they require manual operation by the driver, which may be distracting while driving. Second, a separate space is needed to store the sun visor when not in use, which requires additional package space in the vehicle's interior design. Third, mechanical sun visors are fixed in shape and block certain regions, resulting in unnecessary obstruction of vision as well as the desired blockage of regions where glare occurs.

The latest vehicles, including electric vehicles, are increasingly incorporating wider windshields or glass roofs to emphasize the openness of the cabin. This leaves less room for a sun visor than in conventional vehicles, or mechanical sun visors may not be as effective as they could be.

To solve the present issue, electrochromic glass is being considered for use in vehicles. Electrochromic glass adopts a method of adding film layers, such as a suspended particle device (SPD) and a polymer-dispersed liquid crystal (PDLC), to glass and applying a voltage to control the transmissivity of visible light. The latest vehicles, including electric vehicles, are actively introducing wider windshields or glass roofs to emphasize the openness of the driver's cabin. As a result, there may be insufficient space to mount a sun visor than in conventional vehicles, or mechanical sun visors may not be effective enough.

Therefore, there is a need for a method and apparatus that can compensate for the shortcomings of conventional sun visors and effectively block glare in real time by utilizing electrochromic glass.

### BRIEF SUMMARY

According to various aspects of the present disclosure, the present disclosure provides a method including setting a vertical blocking angular range based on which angular range a vertical angle of incidence falls in among angular ranges determined respectively for a plurality of regions within the electrochromic glass, setting a horizontal blocking angular range based on which angular range a horizontal angle of incidence falls in among the angular ranges determined respectively for the plurality of regions within the electrochromic glass, determining a blocking region based on the vertical blocking angular range and the horizontal blocking angular range, and tinting the blocking region.

According to various aspects of the present disclosure, the present disclosure provides an apparatus including a storing instructions, and at least one processor, wherein at least one processor executing the instructions is configured to perform the steps including setting a vertical blocking angular range based on which angular range a vertical angle of incidence falls in among angular ranges determined respectively for a plurality of regions within the electrochromic glass, setting a horizontal blocking angular range based on which angular range a horizontal angle of incidence falls in among the angular ranges determined respectively for the plurality of regions within the electrochromic glass, determining a blocking region based on the vertical blocking angular range and the horizontal blocking angular range, and tinting the blocking region.

### BRIEF DESCRIPTION OF THE DRAWINGS

FIG. 1 is a schematic block diagram illustrating a configuration of a control system for electrochromic glass in vehicles, according to at least an exemplary embodiment of the present disclosure.

FIG. 2 is a schematic block diagram illustrating a configuration of a vehicle windshield according to at least an exemplary embodiment of the present disclosure.

FIG. 3 is a flowchart of an electrochromic glass control method for vehicles, according to at least an exemplary embodiment of the present disclosure.

FIG. 4 is a diagram illustrating a process for setting a vertical blocking angular range, according to at least an exemplary embodiment of the present disclosure.

FIG. 5 is a diagram of a process for setting a horizontal blocking angular range, according to at least an exemplary embodiment of the present disclosure.

FIG. 6 is a diagram of an illustrative driving path for a driving path-based predictive tinting process according to at least an exemplary embodiment of the present disclosure.

FIG. 7A is a diagram of an illustrative vehicle windshield at a first time point for a driving path-based predictive tinting process according to at least an exemplary embodiment of the present disclosure.

FIG. 7B is a diagram of an illustrative vehicle windshield at a second time point for a driving path-based predictive tinting process according to at least an exemplary embodiment of the present disclosure.

FIG. 7C is a diagram of an illustrative vehicle windshield at a third time point for a driving path-based predictive tinting process according to at least an exemplary embodiment of the present disclosure.

FIG. 8 is a flowchart of an electrochromic glass control method for vehicles, according to another exemplary embodiment of the present disclosure.

FIG. 9A is a diagram illustrating additional blocking regions according to at least an exemplary embodiment of the present disclosure.

FIG. 9B is a diagram illustrating additional blocking regions according to another exemplary embodiment of the present disclosure.

FIG. 10 is a schematic block diagram of an illustrative configuration of a computing device which may be used to implement the apparatuses or methods according to an exemplary embodiment of the present disclosure.

### DETAILED DESCRIPTION

The present disclosure is directed to providing a method and apparatus for controlling electrochromic glass in vehicles. Specifically, the present disclosure provides a method and apparatus for controlling electrochromic glass that analyzes the positional relation between the vehicle and the sun to tint the minimum area exclusively where glare is generated.

The objects of the present disclosure are not limited to those particularly described hereinabove, and the above and other objects that the present disclosure can achieve will be clearly understood by those skilled in the art from the following detailed description.

Hereinafter, various exemplary embodiments of the present disclosure will be described in detail with reference to the accompanying drawings. In the following description, like reference numerals preferably designate like elements, although the elements are shown in different drawings. Furthermore, the following description of various exemplary embodiments will omit, for clarity and brevity, a detailed description of related known components and functions when considered to obscure the subject of the present disclosure.

Various ordinal numbers or alpha codes, such as first, second, i), ii), a), b), etc., are prefixed solely to differentiate one component from the other but not to imply or suggest the substances, order, or sequence of the components. Throughout the present specification, when a part ‘includes’ or ‘comprises’ a component, the part is meant to further include other components, to not exclude thereof unless specifically stated to the contrary.

The following detailed description, along with the accompanying drawings, is directed to illustrate exemplary embodiments of the present disclosure and is not intended to represent the only embodiments in which the present disclosure may be practiced.

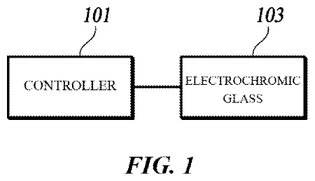

FIG. 1 is a schematic block diagram illustrating a configuration of a control system for electrochromic glass in vehicles, according to at least an exemplary embodiment of the present disclosure.

Referring to FIG. 1, the control system of electrochromic glass in vehicles may include a controller 101 and chromic glass 103. The controller 101 may be configured to determine the angle of incidence of light from a light source onto the chromic glass 103. The controller 101 may be configured to determine the angle of incidence of light from a light source onto the chromic glass 103 by dividing the angle into a vertical direction and a horizontal direction. For example, the controller 101 may be configured to determine the vertical angle of incidence and the horizontal angle of incidence separately. The controller 101 may be configured to determine a blocking region based on the vertical angle of incidence and the horizontal angle of incidence. The blocking region may be a portion of the chromic glass 103. The controller 101 may be configured for controlling the chromic glass 103 to vary the light transmittance of the blocking region within the chromic glass 103. The controller 101 may be configured for controlling a voltage value applied to each of multiple electrodes incorporated in the chromic glass 103 to vary the light transmittance of the blocking region. The controller 101 may be implemented using some or all of the one or more computing devices 100.

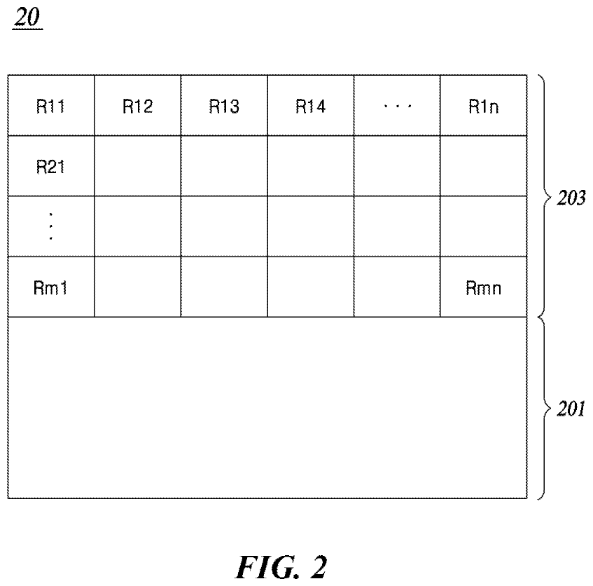

The chromic glass 103 may be electrochromic glass. The electrochromic glass may include electrochromic elements. The chromic glass 103 may be incorporated in a vehicle windshield. The chromic glass 103 may be divided into a plurality of regions. The plurality of regions within the chromic glass 103 will be described in more detail below with reference to FIG. 2. The controller 101 may independently control a light transmittance for each of the regions within the chromic glass 103. For example, the controller 101 may independently control a voltage value applied to each of the multiple electrodes incorporated in each of the regions within the chromic glass 103. The blocking region may be one or more of the individual regions within the chromic glass 103 In the following, the vehicle's electrochromic-glass-control apparatus may be the controller 101, and the electrochromic glass may be the chromic glass 103.

FIG. 2 is a schematic block diagram illustrating a configuration of a vehicle windshield, according to at least an exemplary embodiment of the present disclosure.

FIG. 2 illustrates a vehicle windshield 20. The windshield 20 may include a plain glass 201 and a tinting glass 203. The tinting glass 203 may be chromic glass 103. The tinting glass 203 may be divided into a plurality of regions. The tinting glass 203 may be divided into rectangles of a predetermined size. The tinting glass 203 may be divided into m×n regions. Where m may be the number of rows and n may be the number of columns. For example, if m is 4 and n is 6, the tinting glass 203 may have 24 divided regions. Each region within the tinting glass 203 may be represented using the row and column in which the region is located. In one example, the region located in the first row and first column of the tinting glass 203 may be represented by R11. In another example, the region located in the second row and first column of the tinting glass 203 may be represented by R21. In yet another example, the region located in the first row and fourth column of the tinting glass 203 may be represented by R14.

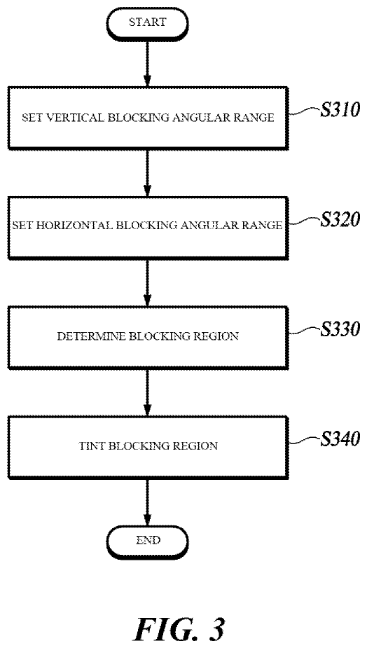

FIG. 3 is a flowchart of an electrochromic glass control method for vehicles, according to at least an exemplary embodiment of the present disclosure.

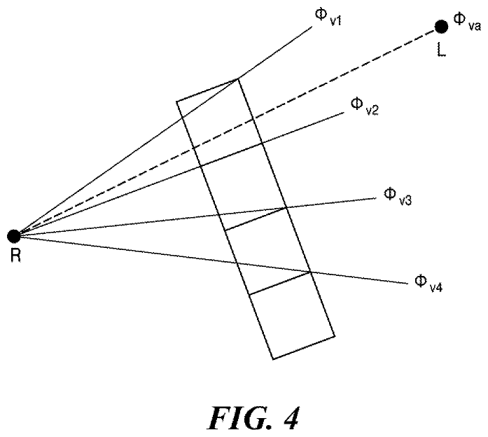

Referring to FIG. 3, the electrochromic-glass-control apparatus may set a vertical blocking angular range (S310). The electrochromic-glass-control apparatus may set the vertical blocking angular range based on which angular range a vertical angle of incidence falls in among angular ranges determined respectively for a plurality of regions within the electrochromic glass. For the present purpose, the electrochromic-glass-control apparatus may be configured to determine a vertical angle of incidence and angular ranges. The method performed by the electrochromic-glass-control apparatus for setting the vertical blocking angular range based on the vertical angle of incidence and the angle ranges will be described in detail below with reference to FIG. 4.

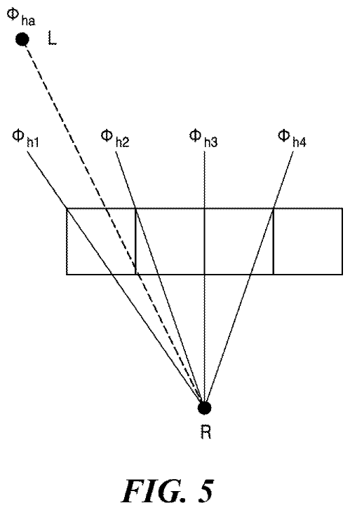

The electrochromic-glass-control apparatus may set a horizontal blocking angular range (S320). The electrochromic-glass-control apparatus may set the horizontal blocking angular range based on which angular range a horizontal angle of incidence falls in among angular ranges determined respectively for a plurality of regions within the electrochromic glass. For the present purpose, the electrochromic-glass-control apparatus may be configured to determine a horizontal angle of incidence and angular ranges. The method performed by the electrochromic-glass-control apparatus for setting the horizontal blocking angular range based on the horizontal angle of incidence and the angle ranges will be described in detail below with reference to FIG. 5.

The electrochromic-glass-control apparatus may be configured to determine a blocking region (S330). The electrochromic-glass-control apparatus may be configured to determine the blocking region based on the vertical blocking angular range and the horizontal blocking angular range.

The electrochromic-glass-control apparatus may tint the blocking region (S340). The electrochromic-glass-control apparatus may exclusively tint a region determined to be a blocking region among a plurality of regions within the electrochromic glass. In other words, the electrochromic-glass-control apparatus may be configured for controlling the light transmittance of a region determined to be a blocking region among a plurality of regions within the electrochromic glass. For example, the electrochromic-glass-control apparatus can decrease the light transmittance of the region determined to be the blocking region. One or more regions of a plurality of regions may be determined to be the blocking region. Thus, the electrochromic-glass-control apparatus according to at least an exemplary embodiment of the present disclosure can determine the blocking region based on the placement of the vehicle and the sun and tint the blocking region to block light over a minimal area exclusively and eliminate glare for the driver.

FIG. 4 is a diagram illustrating a process for setting a vertical blocking angular range, according to at least an exemplary embodiment of the present disclosure. The tinting glass 203 represented by a plurality of rectangles in FIG. 4 may be a view of the tinting glass 203 in a vertical direction. The vertical direction may be a y-z plane. Namely, each of the rectangles in FIG. 4 may represent a respective row of a plurality of regions within the tinting glass 203.

Referring to FIG. 4, the electrochromic-glass-control apparatus may set a vertical blocking angular range based on a vertical angle of incidence and the angular ranges. The angular ranges may be preset. The light-receiving point is the point at which the light is incident, which may be represented by R. The light-receiving point may represent the position of the eyes of an occupant, e.g., the driver. The angular ranges may be set as measured from a reference angle and based on the angles of line segments extending from a light receiving point to the upper end portions of the respective rows belonging to the plurality of regions within the tinting glass 203. The reference angle may be an angle formed by the vehicle relative to the ground. Namely, the reference angle may correspond to the inclination angle of a reference surface of the vehicle, such as the windshield plane, which may be titled with respect to the ground due to the vehicle's orientation or design. The reference angle may be expressed as Φᵥ₀. The inclination angle of the vehicle may be measured using a gyro sensor. The line segments for the respective rows belonging to the plurality of regions within the tinting glass 203 may be based on the light-receiving point and points representing the tops of the respective rows. The line segments for the respective rows form angles in the counterclockwise direction from the reference angle, which may be expressed as Φᵥ₁, Φᵥ₂, Φᵥ₃, Φᵥ₄, and the like. In one example, the line segment connecting the light-receiving point with the point representing the top portion of the first row of tinting glass 203 may form an angle represented by Φᵥ₁ in the counterclockwise direction from the reference angle. In another example, the line segment connecting the light-receiving point with the point representing the top portion of the second row of tinting glass 203 may form an angle represented by Φᵥ₂ in the counterclockwise direction from the reference angle. Referring to FIG. 4, based on the four angles Φᵥ₁, Φᵥ₂, Φᵥ₃, and Φᵥ₄, three angular ranges may be set. The first angular range may be the angles between Φᵥ₁ and Φᵥ₂. The second angular range may be the angles between Φᵥ₂ and Φᵥ₃. The third angle range may be the angles between Φᵥ₃ and Φᵥ₄.

The vertical angle of incidence may be determined based on a light-receiving point and a solar altitude. The electrochromic-glass-control apparatus may be configured to determine the solar altitude based on at least one of the inclination angle of the vehicle, the position of the vehicle, and the current time of day. The inclination angle of the vehicle may be the reference angle. The sun is the light source, which may be represented by L. The vertical angle of incidence may be the angle formed by the line segment connecting the light-receiving point and the light source, counterclockwise from the reference angle. The vertical angle of incidence may be expressed as Φva.

The electrochromic-glass-control apparatus may set the vertical blocking angular range based on which of the angular ranges the vertical angle of incidence falls in. For example, the electrochromic-glass-control apparatus may set the first angular range of the angles between Φᵥ₁ and Φᵥ₂ as the vertical blocking angular range because the vertical angle of incidence Φᵥₐ belongs to the angles between Φᵥ₁ and Φᵥ₂.

FIG. 5 is a diagram of a process for setting a horizontal blocking angular range, according to at least an exemplary embodiment of the present disclosure. The tinting glass 203 represented by the plurality of rectangles in FIG. 5 may be a view of the tinting glass 203 in a horizontal direction. The horizontal direction may be an x-y plane. Namely, each of the rectangles in FIG. 5 may represent a respective column of a plurality of regions within the tinting glass 203.

Referring to FIG. 5, the electrochromic-glass-control apparatus may set a horizontal blocking angular range based on a horizontal angle of incidence and the angular ranges. The angular ranges may be preset. The light-receiving point may represent the position of the eyes of an occupant, e.g., the driver. The angular ranges may be set as measured from a reference angle and based on the angles of line segments for the respective columns belonging to the plurality of regions within the tinting glass 203. The reference angle may be an angle formed by the vehicle relative to the south point. Namely, the reference angle may be an azimuth angle of the vehicle. The reference angle may be expressed as @ho. The azimuth angle of the vehicle may be measured using a geomagnetic sensor. The line segments for the respective columns belonging to the plurality of regions within the tinting glass 203 may be based on the light-receiving point and the points representing the left sides of the respective columns. The line segments for the respective columns form angles in the counterclockwise direction from the reference angle, which may be expressed as Φₕ₁, Φₕ₂, Φₕ₃, Φₕ₄, and the like. In one example, the line segment connecting the light-receiving point with the point representing the left side of the first row of tinting glass 203 may form the angle represented by Φₕ₁ in the counterclockwise direction from the reference angle. In another example, the line segment connecting the light-receiving point with the point representing the left side of the second row of tinting glass 203 may form the angle represented by Φₕ₂ in the counterclockwise direction from the reference angle. Referring to FIG. 5, based on the four angles Φₕ₁, Φₕ₂, Φₕ₃, and Φₕ₄, three angular ranges may be set. The first angle range may be the angles between Φₕ₁ and Φₕ₂. The second angular range may be the angles between Φₕ₂ and Φₕ₃. The third angle range may be the angles between Φₕ₃ and Φₕ₄.

The horizontal angle of incidence may be determined based on a light-receiving point and the position of the sun. The electrochromic-glass-control apparatus may be configured to determine the position of the sun based on at least one of the azimuth angle of the vehicle, the position of the vehicle, and the current time. The azimuth angle of the vehicle may be the reference angle. The sun is a light source, which may be represented by L. The horizontal angle of incidence may be the angle that the line segment connecting the light-receiving point and the light source makes in the counterclockwise direction from the reference angle. The horizontal angle of incidence may be expressed as Pha.

The electrochromic-glass-control apparatus may set the horizontal blocking angular range based on which of the angular ranges the horizontal angle of incidence falls in. For example, the electrochromic-glass-control apparatus may set the first angular range of the angles between Φₕ₁ and Φₕ₂ as the horizontal blocking angular range because the horizontal angle of incidence Φₕₐ belongs to the angles between Φₕ₁ and Φₕ₂.

Referring to FIG. 4 and FIG. 5, the electrochromic-glass-control apparatus may be configured to determine a blocking region based on the set vertical blocking angular range and the set horizontal blocking angular range. The electrochromic-glass-control apparatus may be configured to determine R11 located in the first row and the first column of the plurality of regions within the tinting glass 203 as the blocking region because the vertical incident angle falls within the vertical blocking angular range is between angles Φᵥ₁ and Φᵥ₂, and the horizontal incident angle falls within the horizontal blocking angular range is between angles Φₕ₁ and Φₕ₂.

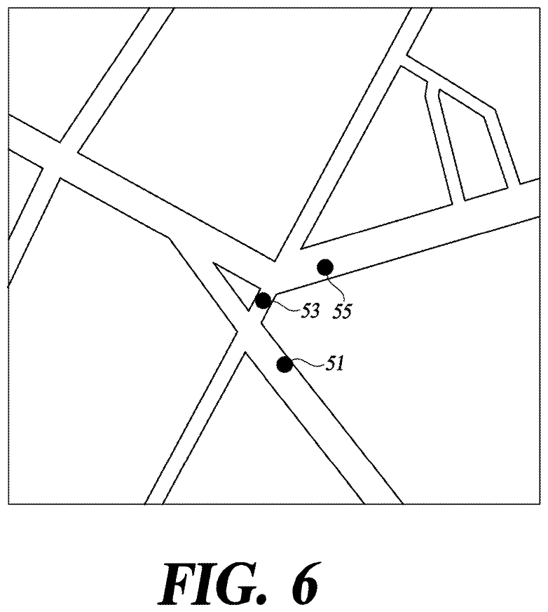

FIG. 6 is a diagram of a reference driving path for describing a driving path-based predictive tinting process according to at least an exemplary embodiment of the present disclosure.

The electrochromic-glass-control apparatus may perform predictive tinting based on the driving path of the vehicle. Namely, the electrochromic-glass-control apparatus may perform a driving path-based predictive tinting process.

The electrochromic-glass-control apparatus may determine, based on the vehicle's position, speed, and driving path at the first time point, the vehicle position at a second time point, which is the predicted location to be reached by the vehicle at the second time point after a predetermined time from the first time point. For example, the electrochromic-glass-control apparatus may obtain the vehicle's position 51 at the first time point and determine the vehicle's position 53 at the second time point based on the vehicle's position 51, speed, and driving path at the first time point. The first time point may be the current time point. The second time point may be a time point after a preset amount of time has elapsed since the first time point. Namely, the electrochromic-glass-control apparatus may be configured to determine the vehicle position at a future time point based on the vehicle's position, speed, and driving path at the current time point. The preset amount of time may be shorter than the transition time of the tinting glass 203. For example, if the transition time of the tinting glass 203 is 30 seconds, the preset time may be 10 seconds. Thus, when the blocking region is expected to change in a shorter time than the transition time of the chromic glass, the electrochromic-glass-control apparatus according to at least an exemplary embodiment of the present disclosure can effectively block light by pre-starting tinting of a blocking region currently determined to need tinting shortly, i.e., a future blocking region to complete tinting of the future blocking region when the future time is reached.

The electrochromic-glass-control apparatus may repeat the above process when the vehicle reaches position 53 after a certain time. It is appropriate that the position 53 after the time is represented by the vehicle position 53 at the first time point again, but for ease of distinction, the vehicle position 53 will be referred to herein with the second time point. The electrochromic-glass-control apparatus may determine, based on the vehicle's position, speed, and driving path at the second time point, the vehicle position at a third time point, which is the predicted location to be reached by the vehicle at the third time point after a predetermined time from the second time point. For example, the electrochromic-glass-control apparatus may obtain the vehicle position 53 at the second time point and determine a vehicle position 55 at the third time point based on the vehicle's position 53, speed, and driving path at the second time point.

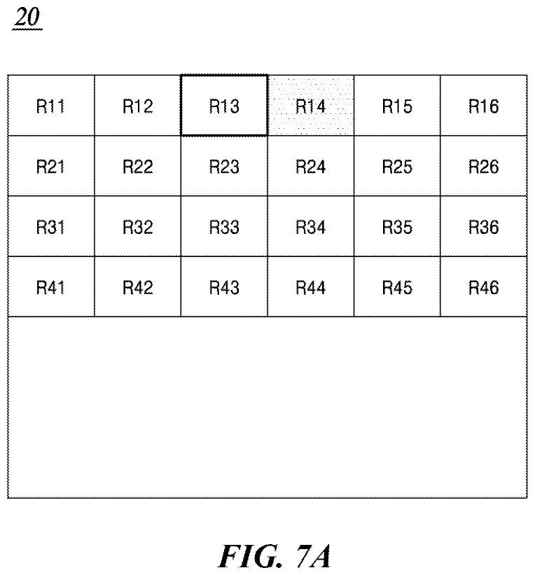

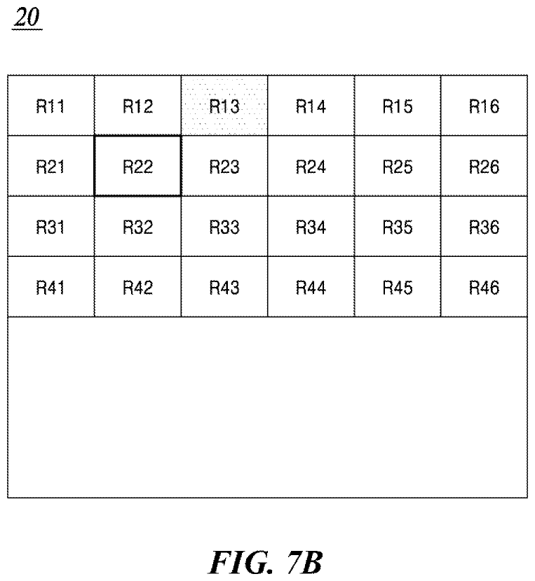

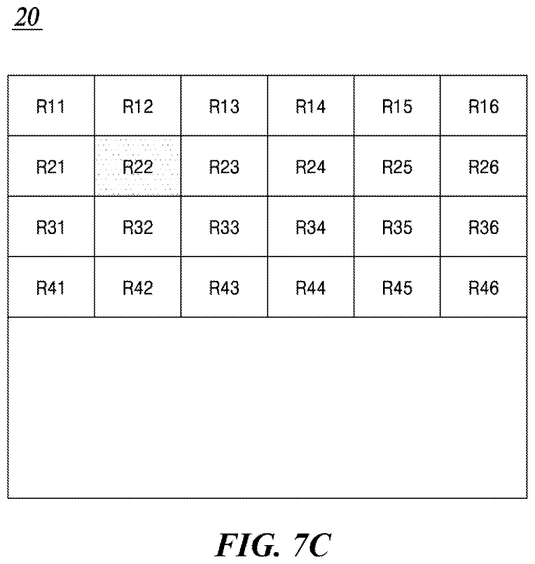

FIG. 7A is a diagram of an illustrative vehicle windshield at the first time point for a driving path-based predictive tinting process according to at least an exemplary embodiment of the present disclosure.

Referring to FIG. 7A, the electrochromic-glass-control apparatus may use the vehicle position at the first time point as a basis to determine a blocking region at the second time point. The electrochromic-glass-control apparatus may be configured to determine the blocking region at the second time point to be R13 based on the determined vehicle position 53 at the second time point, which is based on the vehicle's position 51, speed, and driving path at the first time point. The blocking region at the first time point may be R14. Namely, R14 may have been tinted at the first time point. The electrochromic-glass-control apparatus, as of the first time point, may initiate tinting of the blocking region at the second time point. In other words, the electrochromic-glass-control apparatus may initiate at the first time point the tinting of R13 based on the determination that blocking will be required on R13 at the second time point.

FIG. 7B is a diagram of an illustrative vehicle windshield at the second time point for a driving path-based predictive tinting process according to at least an exemplary embodiment of the present disclosure.

FIG. 7B shows the result of initiating tinting of R13 at the first time point, which is the tinting of R13 completed at the second time point.

The electrochromic-glass-control apparatus may use the vehicle position at the second time point as a basis to determine a blocking region at the third time point. The electrochromic-glass-control apparatus may be configured to determine the blocking region at the third time point to be R22 based on the determined vehicle position 55 at the third time point, which is based on the vehicle's position 53, speed, and driving path at the second time point. The blocking region at the second time point may be R13. Namely, R13 may have been tinted at the second time point. The electrochromic-glass-control apparatus, as of the second time point, may initiate tinting for the blocking region at the third time point. In other words, the electrochromic-glass-control apparatus may initiate at the second time point the tinting of R22 based on the determination that blocking will be required on R22 at the third time point.

FIG. 7C is a diagram of an illustrative vehicle windshield at the third time point for a driving path-based predictive tinting process according to at least an exemplary embodiment of the present disclosure.

FIG. 7C shows the result of initiating tinting of R22 at the second time point, which is the tinting of R22 completed at the third time point. Thus, the electrochromic-glass-control apparatus according to at least an exemplary embodiment of the present disclosure can effectively block light by determining, at a current time point, a blocking region which is determined to require blocking at a future time point, i.e., the future blocking region, and pre-initiating tinting of the future blocking region at the current time point so that the tinting of the future blocking region may be completed at the future time point.

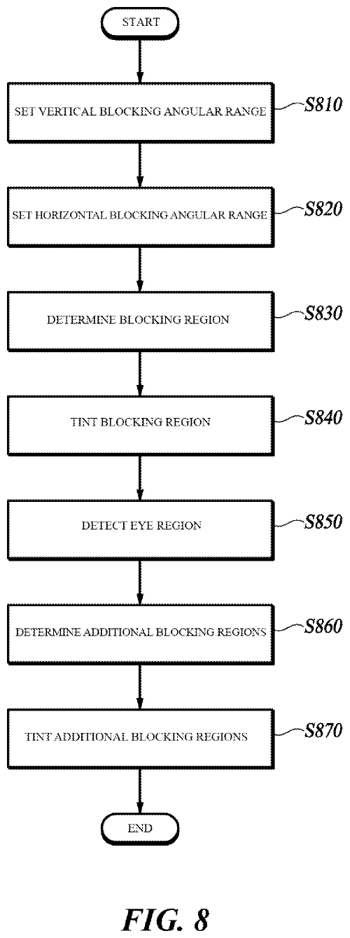

FIG. 8 is a flowchart of an electrochromic glass control method for vehicles, according to another exemplary embodiment of the present disclosure.

Steps S810 through S840 may each be the same as each of Steps S310 through S340. Steps S310 through S340 are each described in detail with reference to FIG. 3 and will not be repeated herein.

The electrochromic-glass-control apparatus may perform a feedback process after the tinting of the blocking region.

The electrochromic-glass-control apparatus may detect an eye region (S850). The electrochromic-glass-control apparatus may detect the eye region from a captured image of the occupant. The captured image of the occupant may be obtained by use of an in-cabin camera (ICC).

The electrochromic-glass-control apparatus may obtain the luminosity of the eye region and the luminosity of the surrounding area. The luminosity of the eye region may be the luminosity of a portion of the captured image of the occupant, corresponding to the detected eye region. The luminosity of the surrounding area may be the luminosity of the remaining portion of the captured image of the occupant, excluding the detected eye region.

The electrochromic-glass-control apparatus may be configured to determine an additional blocking region (S860). The electrochromic-glass-control apparatus may be configured to determine the additional blocking region based on at least one of the luminosity of the eye region and the luminosity of the surrounding area.

According to various exemplary embodiments of the present disclosure, the electrochromic-glass-control apparatus may be configured to determine the additional blocking region if the luminosity of the surrounding area before the tinting of the blocking region is equal to the luminosity of the surrounding area after the tinting of the blocking region, and the luminosity of the eye region after the tinting of the blocking region is higher than the luminosity of the eye region before the tinting of the blocking region. In short, the electrochromic-glass-control apparatus may be configured to determine that the light blocking has failed and determine an additional blocking region if the luminosity of the surrounding area is the same before and after the tinting of the blocking region, but the luminosity of the eye region is higher after the tinting of the blocking region than before.

According to various exemplary embodiments of the present disclosure, the electrochromic-glass-control apparatus may be configured to determine an additional blocking region if the luminosity of the eye region is higher than the luminosity of the surrounding area. For example, the electrochromic-glass-control apparatus may be configured to determine that the light blocking has failed and determine an additional blocking region if the luminosity of the eye region is higher than the luminosity of the surrounding area.

According to various exemplary embodiments of the present disclosure, the electrochromic-glass-control apparatus may be configured to determine an additional blocking region if the difference between the luminosity in the eye region and the luminosity in the surrounding area is below a threshold value. For example, the electrochromic-glass-control apparatus may be configured to determine that the light blocking has failed if the difference between the luminosity in the eye region and the luminosity in the surrounding area is below the threshold value, and may be configured to determine an additional blocking region.

Additional blocking regions may be determined based on the blocking region. In one example, the additional blocking regions may be transversely adjacent to the blocking region. In another example, additional blocking regions may be transversely, longitudinally, and diagonally adjacent to the blocking region.

The electrochromic-glass-control apparatus may tint the additional blocking regions (S870). For example, the electrochromic-glass-control apparatus may be configured to determine and tint the additional blocking regions if the electrochromic-glass-control apparatus determines that light blocking has failed. Thus, the electrochromic-glass-control apparatus according to at least an exemplary embodiment of the present disclosure can effectively block light by determining additional blocking regions and tinting the additional blocking regions if the light blocking based on the blocking region is determined to be failed.

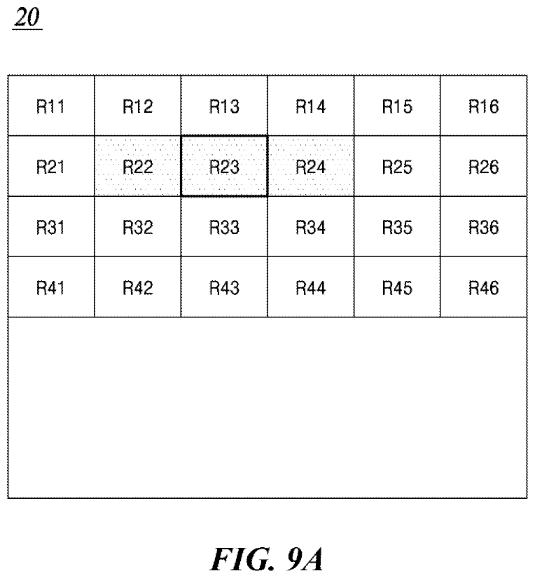

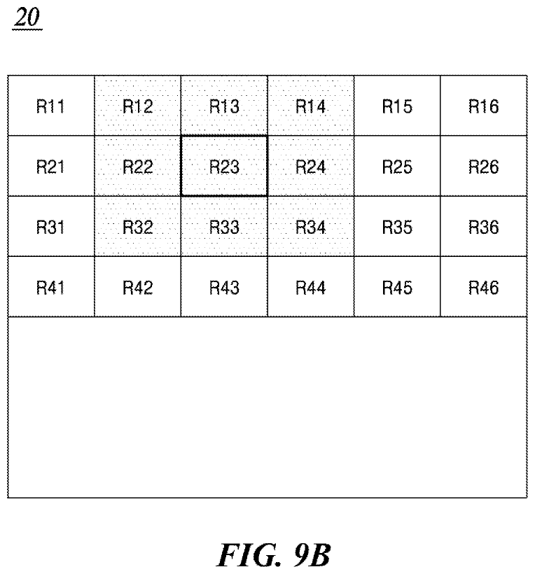

FIG. 9A is a diagram illustrating additional blocking regions according to at least an exemplary embodiment of the present disclosure.

Referring to FIG. 9A, additional blocking regions determined based on the blocking region are shown tinted. The additional blocking regions may be transversely adjacent to the blocking region. After the tinting of the blocking region R23, the electrochromic-glass-control apparatus may be configured to determine additional blocking regions R22 and R24 based on at least one of the luminosity of the eye region and the luminosity of the surrounding area, and tint the additional blocking regions R22 and R24.

FIG. 9B is a diagram illustrating additional blocking regions according to another exemplary embodiment of the present disclosure.

Referring to FIG. 9B, additional blocking regions determined based on the blocking region are shown tinted. The additional blocking regions may be transversely, longitudinally, and diagonally adjacent to the blocking region. After the tinting of the blocking region R23, the electrochromic-glass-control apparatus may be configured to determine the additional blocking regions R12, R13, R14, R22, R24, R32, R33, and R34 based on at least one of the luminosity of the eye region and the luminosity of the surrounding area, and it may tint the additional blocking regions R12, R13, R14, R22, R24, R32, R33, and R34.

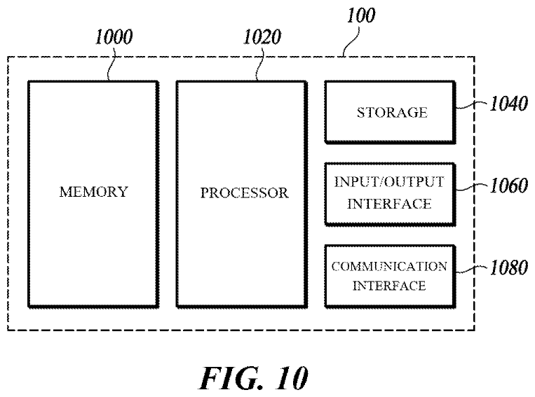

FIG. 10 is a schematic block diagram of an illustrative configuration of a computing device which may be used to implement the methods or apparatuses according to an exemplary embodiment of the present disclosure.

A computing device 100 may be disposed with some or all of a memory 1000, a processor 1020, a storage 1040, an input/output interface 1060, and a communication interface 1080. The computing device 100 may be a stationary computing device, such as a desktop computer, server, or the like, as well as a mobile computing device, such as a laptop computer, smartphone, or the like. The computing device 100 may include any specialized hardware accelerator configured for efficiently processing computations on the artificial intelligence model. For example, the computing device 100 may include a graphics processing unit (GPU), a tensor processing unit (TPU), or a neural processing unit (NPU).

The memory 1000 may store programs that cause the processor 1020 to perform methods or operations under various embodiments of the present disclosure. For example, the program may include a plurality of instructions executable by the processor 1020, and the plurality of instructions may be executed by the processor 1020 to perform the methods or operations described above. The memory 1000 may be a single memory or a plurality of memories. In the instant case, the information required to perform the methods or operations according to various embodiments of the present disclosure may be stored in a single memory or stored divisively among the plurality of memories. When the memory 1000 is composed of a plurality of memories, they may be physically separated. The memory 1000 may include at least one of volatile memory and non-volatile memory. The volatile memory may include static random access memory (SRAM) or dynamic random access memory (DRAM), for example, and the non-volatile memory may include flash memory, for example.

The processor 1020 may include at least one core configured for executing at least one set of instructions. The processor 1020 may execute instructions stored in the memory 1000. The processor 1020 may be a single processor or a plurality of processors.

The storage 1040 maintains stored data even when power to the computing device 100 is interrupted. For example, the storage 1040 may include non-volatile memory or may include a storage medium such as magnetic tape, optical disk, or magnetic disk. Programs stored in the storage 1040 may be loaded into the memory 1000 before execution by the processor 1020. The storage 1040 may store files written in a programming language, and programs generated by a compiler or the like may be loaded from the files into the memory 1000. The storage 1040 may store data to be processed by the processor 1020 and/or data that has been processed by the processor 1020.

The input/output interface 1060 may provide an interface with an input device, such as a keyboard, mouse, etc., and/or with an output device, such as a display device, printer, etc. A user can trigger the execution of a program by the processor 1020 via the input device and/or view the results of processing by the processor 1020 via the output device.

The communication interface 1080 may provide access to an external network. The computing device 100 may communicate with other devices via the communication interface 1080.

The respective components of the apparatus and method may be implemented as hardware or software, or hardware and software combined. Additionally, the function of each component may be implemented by software, and the function by software for each component may be implemented to be executed by a microprocessor.

Various illustrative implementations of the systems and methods described herein may be realized by digital electronic circuitry, integrated circuits, field-programmable gate arrays (FPGAs), application-specific integrated circuits (ASICs), computer hardware, firmware, software, and/or their combination. These various implementations can include those realized in one or more computer programs executable on a programmable system. The programmable system includes at least one programmable processor coupled to receive and transmit data and instructions from and to a storage system, at least one input device, and at least one output device, wherein the programmable processor may be a special-purpose processor or a general-purpose processor. The computer programs (which are also known as programs, software, software applications, or code) contain instructions for a programmable processor and are stored in a “computer-readable recording medium.”

The computer-readable recording medium includes any type of recording device on which data that can be read by a computer system is recordable. Examples of computer-readable recording media include non-volatile or non-transitory media such as a ROM, CD-ROM, magnetic tape, floppy disk, memory card, hard disk, optical/magnetic disk, storage devices, and the like. The computer-readable recording mediums may further include transitory media such as a data transmission medium. Furthermore, the computer-readable recording medium can be distributed in computer systems connected via a network, wherein the computer-readable codes can be stored and executed in a distributed mode.

Although the steps in the respective flowcharts/timing charts are described in the present specification as being sequentially performed, they merely instantiate the technical idea of various exemplary embodiments of the present disclosure. Therefore, a person having ordinary skill in the pertinent art to the respective embodiments could perform the steps without departing from the idea and scope of the embodiments by changing the sequences described in the respective flowcharts/timing charts or by performing two or more of the steps in parallel, and hence the steps in the respective flowcharts/timing charts are not limited to the illustrated chronological sequences.

According to at least an exemplary embodiment of the present disclosure, by determining the blocking region based on the placement of the vehicle and the sun and tinting the blocking region, only a minimal area of light is blocked, and glare for the driver is eliminated.

According to at least an exemplary embodiment of the present disclosure, if the blocking region is expected to change in a time shorter than the transition time of the chromic glass, tinting of the blocking region which is determined to need blocking at a future time point, i.e., the future blocking region, may be initiated in advance to complete the tinting of the future blocking region when the future time point is reached, effectively blocking light.

According to at least an exemplary embodiment of the present disclosure, the light may be effectively blocked by determining, at a current time point, the future blocking region, a blocking region which is determined to need blocking at a future time point, and pre-initiating tinting of the future blocking region at the current time point to complete the tinting of the future blocking region when it comes to the future time point.

In at least an exemplary embodiment of the present disclosure, if blocking light based on a blocking region is determined to be unsuccessful, additional blocking regions may be determined and tinting of the additional blocking regions may be performed to effectively block light.

The effects of the present disclosure are not limited to those mentioned above, and other effects not mentioned will be apparent to those of ordinary skill in the art from the above description.

Although exemplary embodiments of the present disclosure have been described for illustrative purposes, those skilled in the art will appreciate that various modifications, additions, and substitutions are possible without departing from the idea and scope of the claimed invention. Therefore, various exemplary embodiments of the present disclosure have been described for the sake of brevity and clarity. The scope of the technical idea of the embodiments of the present disclosure is not limited by the illustrations. Accordingly, one of ordinary skill would understand that the scope of the claimed invention is not to be limited by the above explicitly described embodiments but by the claims and equivalents thereof.

What is claimed is:

1. A method comprising:
setting a vertical blocking angular range based on which angular range a vertical angle of incidence falls in among angular ranges determined respectively for a plurality of regions within the electrochromic glass;
setting a horizontal blocking angular range based on which angular range a horizontal angle of incidence falls in among the angular ranges determined respectively for the plurality of regions within the electrochromic glass;
determining a blocking region based on the vertical blocking angular range and the horizontal blocking angular range; and
tinting the blocking region.

2. The method of claim 1, further comprising, after the tinting of the blocking region:
detecting, from an image taken of an occupant of the vehicle, an eye region of the occupant;
determining an additional blocking region based on at least one of a luminosity of the eye region, or a luminosity of a surrounding area, or combinations thereof; and
tinting the additional blocking region.

3. The method of claim 1, further comprising:
determining, based on a position, a speed, and a driving path of the vehicle at a first time point, a predicted vehicle position at a second time point after a predetermined time from the first time point;
determining a blocking region at the second time point based on the vehicle position at the second time point; and
initiating, at the first time point, a tinting of the blocking region at the second time point.

4. The method of claim 2, wherein the determining of the additional blocking region based on the at least one of the luminosity of the eye region, or the luminosity of the surrounding area, or combinations thereof includes:
determining the additional blocking region based on that the luminosity of the surrounding area before the tinting of the blocking region is equal to the luminosity of the surrounding area after the tinting of the blocking region, and the luminosity of the eye region after the tinting of the blocking region is higher than the luminosity of the eye region before the tinting of the blocking region.

5. The method of claim 2, wherein the determining of the additional blocking region based on the at least one of the luminosity of the eye region, or the luminosity of the surrounding area, or combinations thereof comprises:
determining the additional blocking region based on that the luminosity of the eye region is higher than the luminosity of the surrounding area.

6. The method of claim 2,
wherein the image taken of the occupant of the vehicle is taken with a reference exposure adapted to the eye region, and
wherein the determining of the additional blocking region based on the at least one of the luminosity of the eye region, or the luminosity of the surrounding area, or combinations thereof comprises:
determining the additional blocking region based on that the luminosity of the eye region and the luminosity of the surrounding area are different by a value which is equal to or smaller than a threshold.

7. The method of claim 3, wherein the determining of the blocking region at the second time point based on the vehicle position at the second time point comprises:
determining, based on the vehicle position at the second time point, the vertical angle of incidence, the horizontal angle of incidence, and the angular ranges at the second time point, which are respectively different from the vertical angle of incidence, the horizontal angle of incidence, and the angular ranges at the first time point;
setting the vertical blocking angular range based on which angular range the vertical angle of incidence at the second time point falls in among the angular ranges at the second time point;
setting the horizontal blocking angular range based on which angular range the horizontal angle of incidence at the second time point falls in among the angular ranges at the second time point; and
determining the blocking region at the second time point based on the vertical blocking angular range and the horizontal blocking angular range.

8. The method of claim 3, wherein the first time point and the second time point include a time difference which is less than a time taken for each of the plurality of regions within the electrochromic glass to reach a preset tinting percentage.

9. A non-transitory computer readable storage medium on which a program for performing the method of claim 1 is recorded.

10. An apparatus comprising:
a memory storing instructions; and
at least one processor,
wherein the at least one processor executing the instructions performs steps comprising:
setting a vertical blocking angular range based on which angular range a vertical angle of incidence falls in among angular ranges determined respectively for a plurality of regions within the electrochromic glass;
setting a horizontal blocking angular range based on which angular range a horizontal angle of incidence falls in among the angular ranges determined respectively for the plurality of regions within the electrochromic glass;
determining a blocking region based on the vertical blocking angular range and the horizontal blocking angular range; and
tinting the blocking region.

11. The apparatus of claim 10, wherein the at least one processor performs, after the tinting of the blocking region:
detecting, from an image taken of an occupant of the vehicle, an eye region of the occupant;
determining an additional blocking region based on at least one of a luminosity of the eye region, or a luminosity of a surrounding area, or combinations thereof; and
tinting the additional blocking region.

12. The apparatus of claim 10, wherein the at least one processor further performs:
determining, based on a position, a speed, and a driving path of the vehicle at a first time point, a predicted vehicle position at a second time point after a predetermined time from the first time point;
determining a blocking region at the second time point based on the vehicle position at the second time point; and
initiating, at the first time point, a tinting of the blocking region at the second time point.

13. The apparatus of claim 11, wherein the determining of the additional blocking region based on the at least one of the luminosity of the eye region, or the luminosity of the surrounding area, or combinations thereof comprises:
determining an additional blocking region based on that the luminosity of the surrounding area before the tinting of the blocking region is equal to the luminosity of the surrounding area after the tinting of the blocking region, and the luminosity of the eye region after the tinting of the blocking region is higher than the luminosity of the eye region before the tinting of the blocking region.

14. The apparatus of claim 11, wherein the determining of the additional blocking region based on the at least one of the luminosity of the eye region, or the luminosity of the surrounding area, or combinations thereof comprises:
determining the additional blocking region based on that the luminosity of the eye region is higher than the luminosity of the surrounding area.

15. The apparatus of claim 11,
wherein the image taken of the occupant of the vehicle is taken with a reference exposure adapted to the eye region, and
wherein the determining of the additional blocking region based on the at least one of the luminosity of the eye region, or the luminosity of the surrounding area, or combinations thereof comprises:
determining the additional blocking region based on that the luminosity of the eye region and the luminosity of the surrounding area are different by a value which is equal to or smaller than a threshold.

16. The apparatus of claim 12, wherein the determining of the blocking region at the second time point based on the vehicle position at the second time point comprises:
determining, based on the vehicle position at the second time point, the vertical angle of incidence, the horizontal angle of incidence, and the angular ranges at the second time point, which are respectively different from the vertical angle of incidence, the horizontal angle of incidence, and the angular ranges at the first time point;
setting the vertical blocking angular range based on which angular range the vertical angle of incidence at the second time point falls in among the angular ranges at the second time point;
setting the horizontal blocking angular range based on which angular range the horizontal angle of incidence at the second time point falls in among the angular ranges at the second time point; and
determining the blocking region at the second time point based on the vertical blocking angular range and the horizontal blocking angular range.

17. The apparatus of claim 12, wherein the first time point and the second time point include a time difference which is less than a time taken for each of the regions within the electrochromic glass to reach a preset tinting percentage.

18. A vehicle comprising the apparatus for controlling the electrochromic glass of claim 10.
